(19) United States
(12) Patent Application Publication
(10) Pub. No.: US 2003/0196284 A1
(43) Pub. Date: Oct. 23, 2003

(54) Apparatus for the preparation and/or regeneration of fabric detergent reels for cleaning printing cylinders or cylinders of equivalent precision

(75) Inventors: Marcello Ghisalberti, Pedrengo (IT); Lorenzo Ghisalberti, Stezzano (IT)

Correspondence Address: YOUNG & THOMPSON, 745 SOUTH 23RD STREET 2ND FLOOR, ARLINGTON, VA, 22202

(73) Assignee: T.G.C. S.R.L., GRASSOBBIO (IT)

(21) Appl. No.: 10/419,189

(22) Filed: Apr. 21, 2003

(30) Foreign Application Priority Data
Apr. 23, 2002 (IT) BG2002A000015

(51) Int. Cl. B08B 1/02

(52) U.S. Cl. 15/77; 15/102; 15/256.5; 134/61; 68/204

(57) ABSTRACT

This apparatus for the preparation and/or regeneration of detergent reels of fabric for cleaning printing cylinders or cylinders of similar precision has the characteristic of impregnating the fabric (4) by its immersed transit through a suitable container (10), and by a subsequent sinuous passage involving its pressing and folding in alternate directions by a plurality of rollers implementing uniform distribution of the detergent, said passage terminating with winding the fabric into a new reel (8) of collected fabric which, thus treated, has acquired and/or conserved properties suitable for its use.

### DESCRIPTION

This invention relates to the preparation and/or regeneration of detergent reels for cleaning printing cylinders or cylinders of equivalent precision.

Rotary cylinders provided with extremely smooth surfaces of millesimal precision are known to operate in certain industrial sectors.

The most emblematic field of such cylinders is that of printing machines; there are however other sectors in which cylinders with extremely precise and/or delicate surfaces operate: for example, film laminating cylinders.

In all these cases the surface of such cylinders must be cleaned to remove any particles resulting from their operation.

This must be achieved by methods which are effective while at the same time being extremely delicate.

For this purpose woven or non-woven fabrics are used wound into suitable reels, they being suitably wetted with detergent and then brought into contact with the rotating cylinder to remove any impurities from it.

Automatic cleaning apparatus for printing machines are known in the state of the art, such as that described in Italian patent 1306450, which use a woven or non-woven fabric to remove deposits and impurities from the outer surface of rotary cylinders or rollers.

During their operation said apparatus unwind a portion of fabric from a reel: if scheduled by their intervention program and if necessary, said systems wet the said fabric portion with detergent and then make it adhere to the surface to be cleaned. The fabric portion used in this manner is then rewound on a reel. When the required fabric portions are no longer available, the reel with the used fabric portions is disposed of.

In these known systems the detergent is distributed on the fabric in a non-uniform manner which causes part of the detergent to be dispersed into the environment as an aeriform, because the distribution takes place by spraying.

Moreover these cleaning systems do not provide for reusing fabric which has already been wetted.

An object of the present invention is to define an apparatus which provides reels of woven fabric or other equivalent materials such as non-woven fabric, which are impregnated by detergent in an optimum manner for use in cleaning said printing cylinders or the like.

Another object is to define an apparatus, as aforestated, which is able to provide reels obtained from fabric already used in previous cleaning.

Another object is to define an apparatus, as aforestated, which is able to provide pre-impregnated reels using either unused or already used fabrics.

Another object is to define an apparatus, as aforestated, which enables reusable reels of fabric to be produced having dimensions different from those of the recycled reel used for the initial cleaning.

Another object is to define an apparatus, as aforestated, which results in substantial operating economy.

These and further objects will be seen to have been attained on reading the following detailed description of an apparatus for the preparation and/or regeneration of detergent reels of fabric or the like for cleaning printing cylinders or cylinders of similar precision, characterised by impregnating the fabric by its immersed transit through a suitable container, and by a subsequent sinuous passage involving its pressing and folding in alternate directions by a plurality of rollers implementing uniform distribution of the detergent, said passage terminating with its winding into a new reel of collected fabric which, thus treated, has acquired and/or conserved properties suitable for its use.

The invention is illustrated by way of non-limiting example in the accompanying drawings, in which:

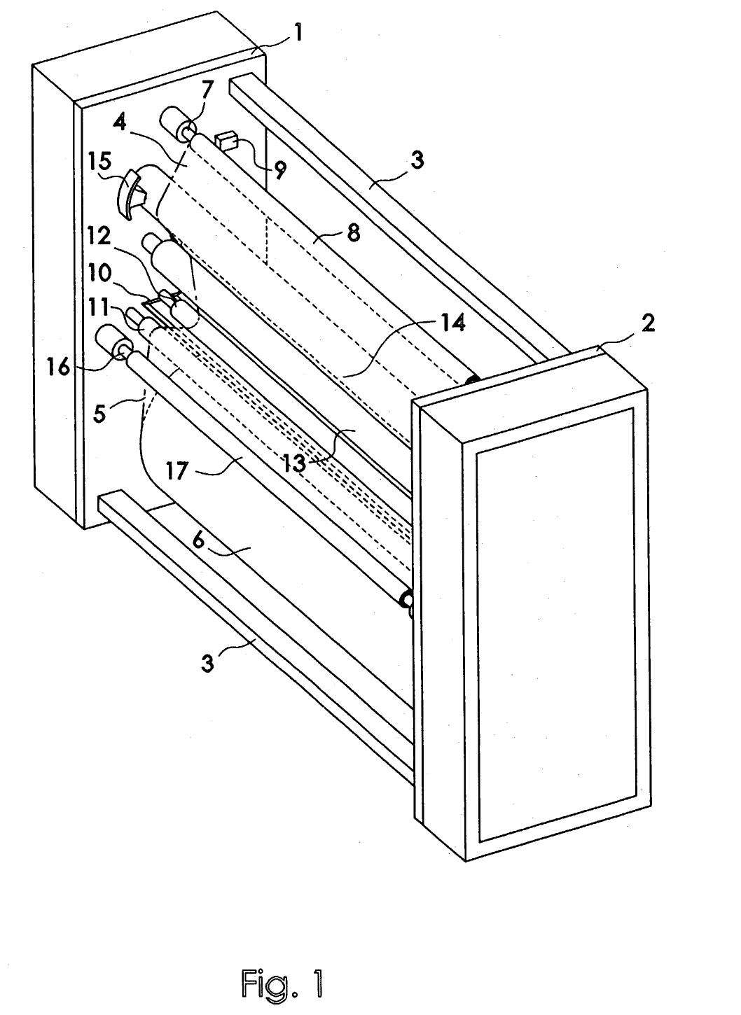

FIG. 1 is a perspective view of a device for the preparation and regeneration of reels of fabric or the like, with cleaning action;

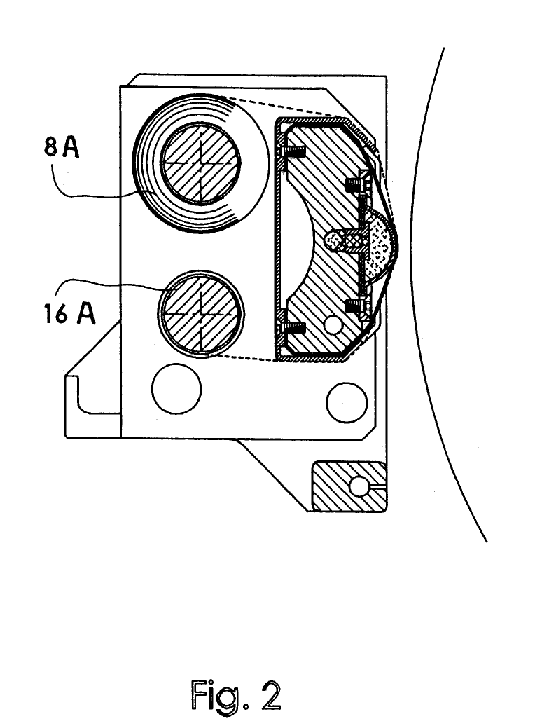

FIG. 2 is a vertical section through a cleaning device for rotary cylinders using the fabric reels of the invention;

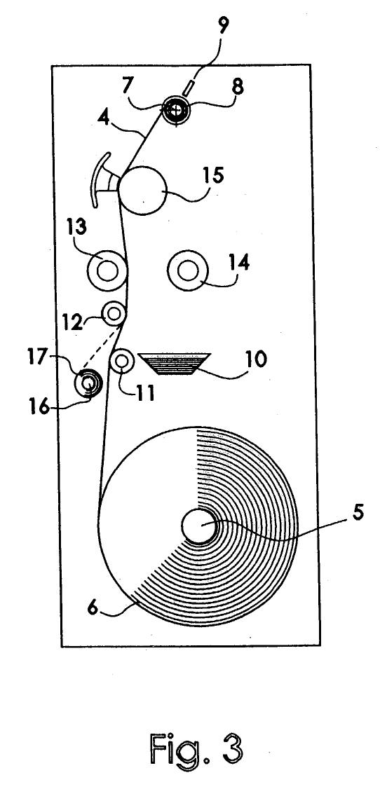

FIG. 3 is a schematic side view of an embodiment of an apparatus according to the invention;

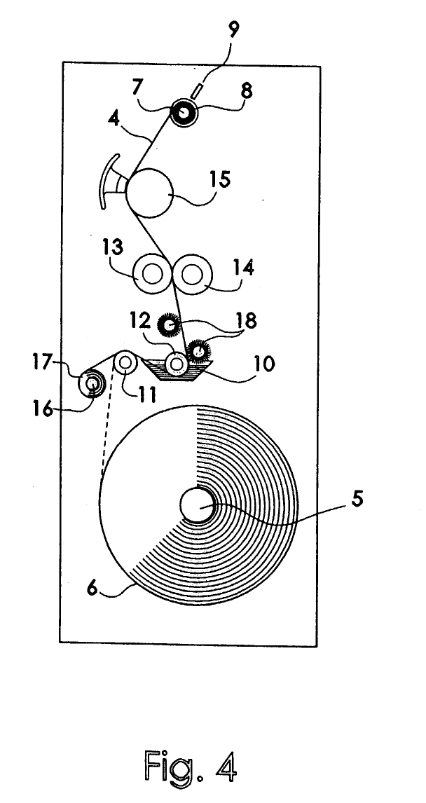

FIG. 4 is a schematic side view of another embodiment of an apparatus according to the invention in another operative condition;

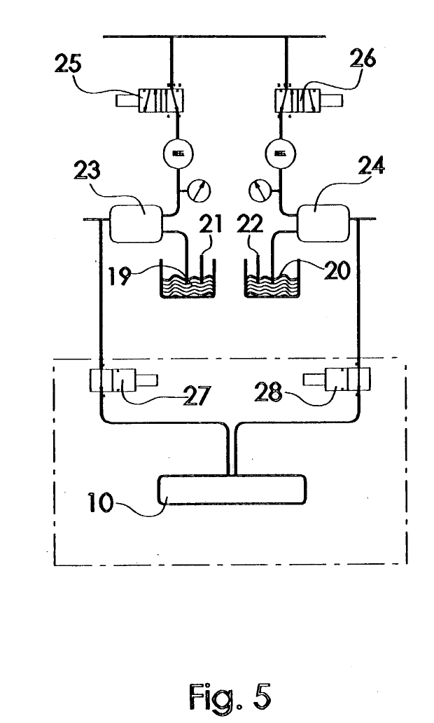

FIG. 5 is a diagram of those components of the apparatus involved in dispensing and feeding the detergent;

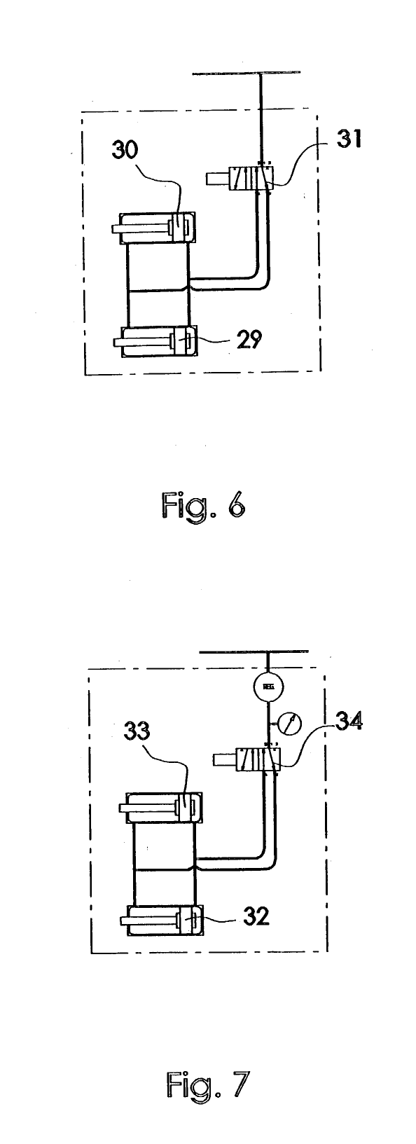

FIG. 6 is a diagram of those components of the apparatus involved in moving a wetting roller;

FIG. 7 is a diagram of those components involved in positioning the rollers for pressing the wetted fabric after it has been unwound from its reel.

With reference to FIGS. 1, 3, 4, the apparatus comprises two vertically extending parallel side walls 1, 2 connected together by longitudinal elements 3, on which the various components for supporting, moving and treating a fabric 4 are mounted.

The term “fabric” is used generically herein in the sense that it also includes equivalent materials such as non-woven fabric, or generic sheets of other material of similar consistency, liquid absorption capacity and cleaning capacity.

The said apparatus also comprises a removable rotatable feed shaft 5 for supporting a reel 6 of new fabric. From this reel a fabric portion 4 can be unwound by winding it simultaneously on a new reel 8 of smaller diameter supported by a winding shaft 7.

From the constituent quantities of fabric from the reel 6 a plurality of new reels 8 can be formed in sequence, these being identical or different to make them dimensionally compatible with the various types of the various machine types.

In operation, after the end of the fabric 4 has been fixed to the winder shaft 7, this latter is rotated by a gearmotor (not shown), until the new fabric reel is complete.

A sensor or electromechanical switch 9, located in proximity to the winding shaft 7, halts it as soon as the predetermined diameter for the new reel 8 has been reached, this depending on the characteristics of the user machine.

FIG. 2 shows a typical cleaning device present on such machines, and shows how the fabric (indicated by dashed lines) unwinds from a reel 8A, to be rewound on a take-up reel, driven by a shaft 16A, after sliding over a device which causes it to approach the cylindrical surface of the roller to be cleaned (shown on the right by a circular arc).

Experimental tests have shown that the fabric, if not particularly soiled and worn, can be reused several times. The apparatus of the invention can therefore also unwind the fabric from a take-up shaft 16, supported rotatable and removable, on which the fabric has been wound as a reel 17 during the use of the machine cleaning system, and rewind it onto the shaft 7 as a new reel 8 (FIGS. 3, 4).

Before reaching the winding shaft 7, the fabric 4 (unwound as described) passes between a pair of rollers 11, 12 rotatable on command about the axis of the roller 11.

This enables the fabric 4 to follow either a “dry path” such as that shown in FIG. 3, or a “wet path” such as that show in FIG. 4.

In this respect, FIG. 4 shows that the roller 12, after its movement about the axis of the roller 11, is immersed in a container 10 of the wetting system.

In FIG. 3 the fabric 4 follows a path which, shown by full lines, extends from the reel 6 to the new reel 8 or, alternatively, a path, indicated by dashed lines, which extends from the reel 17 to the new reel 8.

Likewise, in FIG. 4 the fabric 4 can derive either from the unwinding of the reel 6 or from the unwinding of the reel 17 supported by the shaft 16.

The said container 10 contains detergent and dilution water, these originating from two storage tanks 19 and 20, or directly from a specific drum of detergent and from the water main.

If present as shown in FIG. 5, said tanks 19, 20 are provided with level controls 21 and 22, to prevent the device operating if detergent and/or water are absent, these being connected to pumps 23 and 24 which, controlled by solenoid valves 25 and 26, feed the wash solution to the container 10 at suitable pressure.

Further solenoid valves 27, 28, operated at predetermined time intervals by the electronic control unit of the device, enable the quantities of detergent and water fed into the container 10 to be regulated, so defining the quality of the wash solution.

Different types and degrees of soiling require the use of different combinations: use of the detergent alone, undiluted in water; use of water alone; or use of the mixture thereof in different concentrations. In

operation, the wetting roller 12, located in proximity to the container 10 and parallel to it, is made to approach (when required) the container 10 until partially immersed in the wash solution.

This wetting roller 12 can also be withdrawn from the container 10. Said approach or withdrawal movements are determined by pneumatic actuators 29 and 30, controlled by a solenoid valve 31 (FIG. 6).

For a wetting operation aimed at reusing the fabric, the action of one or more additional wash rollers is advantageous but not indispensable. Said additional rollers cooperate with the wetting roller 12; they can be partially immersed in the container 10 or at least positioned in proximity to the wetting roller 12, as visible in FIG. 4.

The additional rollers 18 are operable at variable speed and one or both can be replaced by other cleaning means, such as a fixed brush, or a rotary brush, or a scraper blade of suitable flexibility.

After being wetted and/or washed by its passage through the container 10 and about the appropriate said rollers, the fabric 4 passes between two cooperating squeezer rollers 13, 14 positioned at an adjustable distance apart (see FIGS. 3 and 4).

Said squeezer rollers wring the fabric to remove the excess detergent from it and determine, by the pressure exerted in their contact region, the optimum residual quantity of liquid in the fabric.

The purpose of this is to adapt the fabric impregnation to the utilization conditions and the structural and operational characteristics of the user machine. The wringing is applied in order to adapt the said impregnation to the characteristics of the detergent (drying time, volatility, cleaning power) and of the fabric itself (absorption capacity, mechanical strength).

The relative position of the two squeezer rollers 13 and 14 can be modified either directly by the operator or by usual automatic servo-mechanisms.

One example of such servo-mechanisms is represented by the pneumatic actuators 32 and 33, which are controlled by a solenoid valve 34 (as shown in FIG. 7) and operate while the fabric 4 is being wound onto the shaft 7 to form the reel 8.

In this manner the fabric 4 can advantageously retain, for example, a greater quantity of detergent in the initial stage of its winding (inner part of the reel 8) and, vice versa, a smaller quantity in the final stage (outer part of the reel 8); this is to compensate for differential drying or irregular distribution with time, of the detergent within the reel of fabric.

In this respect, although the reel of fabric 8 is intended for virtually immediate use on the machine in the place in which the apparatus of the invention is located, it has been found experimentally that the detergent tends to concentrate, with time, in certain regions of the reel, mostly outer regions.

A usual manual or motorized cutting unit 16 is provided with a blade slidable transversely to the fabric winding direction; this enables the new reel 8 to be removed and later used in the cleaning device.

Advantageously, the apparatus of the invention enables properly wound reels of the required diameter to be quickly prepared; it also enables the fabric to be uniformly pre-wetted with optimum dispensing of the wash solution.

Another advantage is the incorporation of a cutting unit with a usual sliding blade, to obtain accurate fabric ends which facilitate their winding for reeling.

Another advantage is the regeneration of used fabric reels.

Further benefits of indirect type are represented by the fact that the apparatus of the invention results in more effective and rapid rotary cylinder cleaning.

Said apparatus also requires low maintenance for the fabric wetting systems, which do not require detergent to be fed into the machine.

Finally, there is also a reduction in the consumption both of fabric and of detergent.

1. An apparatus for the preparation and/or regeneration of detergent reels of fabric for cleaning printing cylinders or cylinders of similar precision, characterised by impregnating the fabric,(4) by its immersed transit through a suitable container (10), and by a subsequent sinuous passage involving its pressing and folding in alternate directions by a plurality of rollers implementing uniform distribution of the detergent, said passage terminating with winding the fabric into a new reel (8) of collected fabric which, thus treated, has acquired and/or conserved properties suitable for its use.

2. An apparatus as claimed in the preceding claim, characterised in that the treatment of the fabric (4) uses squeezer rollers (13, 14).

3. An apparatus as claimed in the preceding claims, characterised by comprising a pair of rollers (11, 12) rotatable about an axis of one of them (11) by the action of pneumatic actuators (29, 30) controlled by solenoid valves (31), to enable the path of the fabric sliding between them to be varied in order to vary the extent, from zero to an optimum value, of its immersion into the detergent container (10) for impregnation.

4. An apparatus as claimed in the preceding claims, characterised by comprising a usual cutting unit of blade type slidable in a direction perpendicular to the winding direction of the fabric (4).

5. An apparatus as claimed in the preceding claims, characterised in that the pair of rollers (11, 12) regulating the immersion of the fabric (4) into the detergent container (10) is positioned downstream of reels of detergent fabric to enable the use of used fabrics taken from a reel (17) positioned on a suitable shaft (16) and previously formed by their unwinding from the reel (8) during the use of the cleaning device, as an alternative to the use of new fabric taken from a reel (6) located on a specific shaft (5).

6. An apparatus as claimed in the preceding claims, characterised in that the new reel (8) is formed from a number of turns of fabric (4) established by an electronic sensor or electromechanical switch (9) sensing a predetermined diameter.

7. An apparatus as claimed in the preceding claims, characterised by comprising auxiliary rollers (18) for wetting the fabric with the detergent liquid and distributing it thereon.

8. An apparatus as claimed in the preceding claims, characterised in that the container (10) contains detergent and dilution water originating from two storage tanks (19, 20).

9. An apparatus as claimed in the preceding claims, characterised in that the container (10) contains detergent and dilution water originating respectively from a specific drum and from the water main.

10. An apparatus as claimed in the preceding claims, characterised in that said tanks or drums are provided with level sensors (21, 22) arranged to electrically interrupt the operation of the apparatus in known manner if the required liquids are absent.

11. An apparatus as claimed in the preceding claims, characterised in that said tanks (19, 20) or drums are emptied by pumps (23, 24) which feed the wash solution to the container (10) under the control of suitable solenoid valves (25, 26).

12. An apparatus as claimed in the preceding claims, characterised by comprising further solenoid valves (27, 28) operated at predetermined time intervals by a usual electronic control unit for the device, to regulate the relative detergent and water quantities fed into the container (10), and hence define the quality of the wash solution.

13. An apparatus as claimed in the preceding claims, characterised by comprising means replacing the auxiliary rollers (18), said replacement means consisting of fixed or rotary brushes, or scraper blades of suitable flexibility.

14. An apparatus as claimed in the preceding claims, characterised by comprising cooperating squeezer rollers (13, 14) positioned at a distance apart which can be adjusted manually and/or by usual automatic servo-mechanisms.

15. An apparatus as claimed in the preceding claims, characterised in that said servo-mechanisms consist of pneumatic actuators (32, 33) controlled by solenoid valves (34) such as to enable differential wringing on the basis of a rational distribution of the detergent within the reel under formation.
